(19) United States
(12) Patent Application Publication
(10) Pub. No.: US 2018/0161224 A1
(43) Pub. Date: Jun. 14, 2018

(54) AMBULATORY ASSISTANCE ASSEMBLY

(71) Applicant: Rey Forro, Aliso Viejo, CA (US)

(72) Inventor: Rey Forro, Aliso Viejo, CA (US)

(21) Appl. No.: 15/375,939

(22) Filed: Dec. 12, 2016

(51) Int. Cl. A61G 7/053

(52) U.S. Cl. CPC A61G 7/053

(57) ABSTRACT

An ambulatory assistance assembly includes a base unit that may be positioned on a support surface. The base unit may be aligned with a bed thereby facilitating a user to stand on the base unit. The base unit has a pair of rotatable disks to facilitate the user to align themselves with a wheelchair when the user is standing on the base unit. A handle unit is coupled to the base unit and the handle unit is gripped by the user when the user stands on the base unit thereby facilitating the user to selectively transfer themselves between the wheelchair and the bed.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

[symbol]

### (2) Description of Related Art Including Information Disclosed Under 37 CFR 1.97 and 1.98

The disclosure and prior art relates to assistance devices and more particularly pertains to a new assistance device for assisting a physically disabled user to transfer themselves between a bed and a wheelchair.

### BRIEF SUMMARY OF THE INVENTION

An embodiment of the disclosure meets the needs presented above by generally comprising a base unit that may be positioned on a support surface. The base unit may be aligned with a bed thereby facilitating a user to stand on the base unit. The base unit has a pair of rotatable disks to facilitate the user to align themselves with a wheelchair when the user is standing on the base unit. A handle unit is coupled to the base unit and the handle unit is gripped by the user when the user stands on the base unit thereby facilitating the user to selectively transfer themselves between the wheelchair and the bed.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of an ambulatory assistance assembly according to an embodiment of the disclosure.

FIG. 2 is a front phantom view of an embodiment of the disclosure.

FIG. 3 is a left side view of an embodiment of the disclosure.

FIG. 4 is a bottom view of an embodiment of the disclosure.

FIG. 5 is a perspective in-use view of an embodiment of the disclosure.

### DETAILED DESCRIPTION OF THE INVENTION

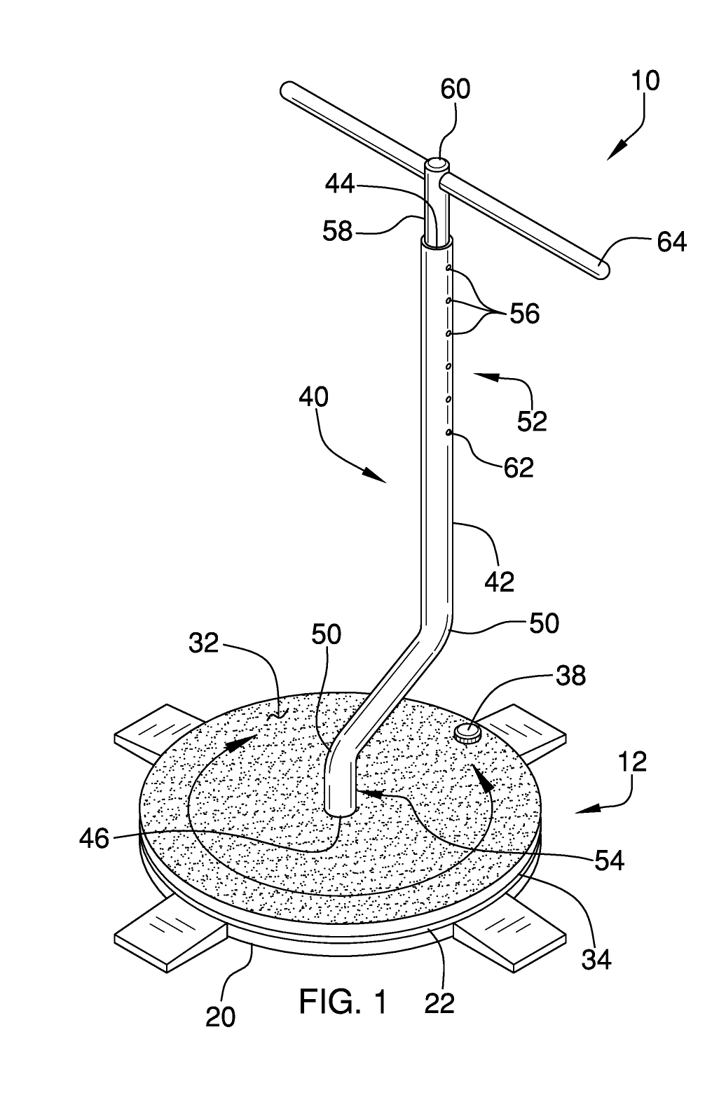

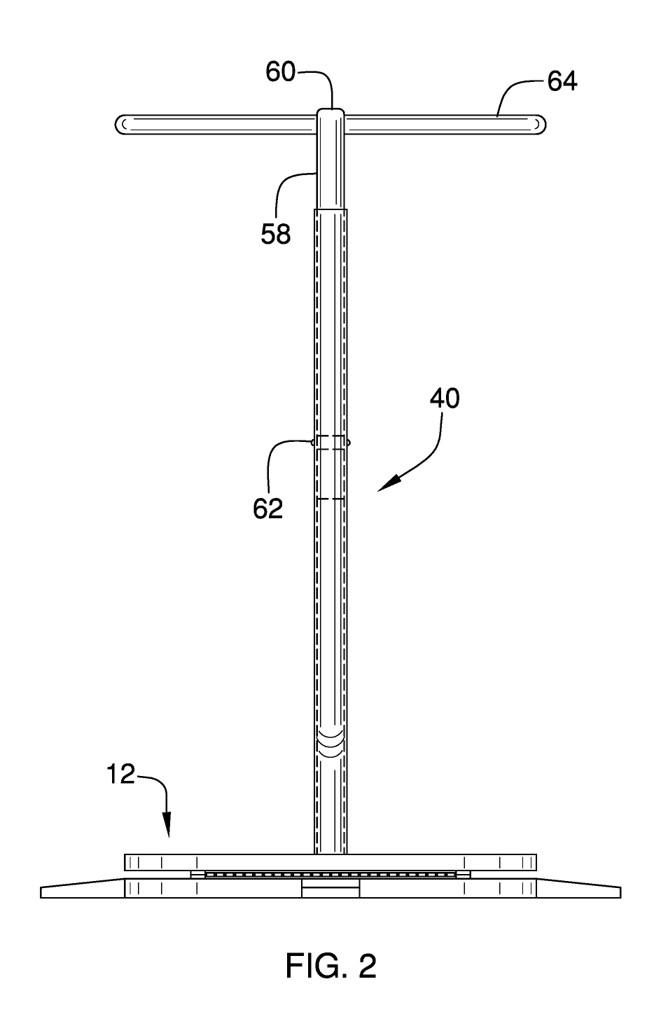

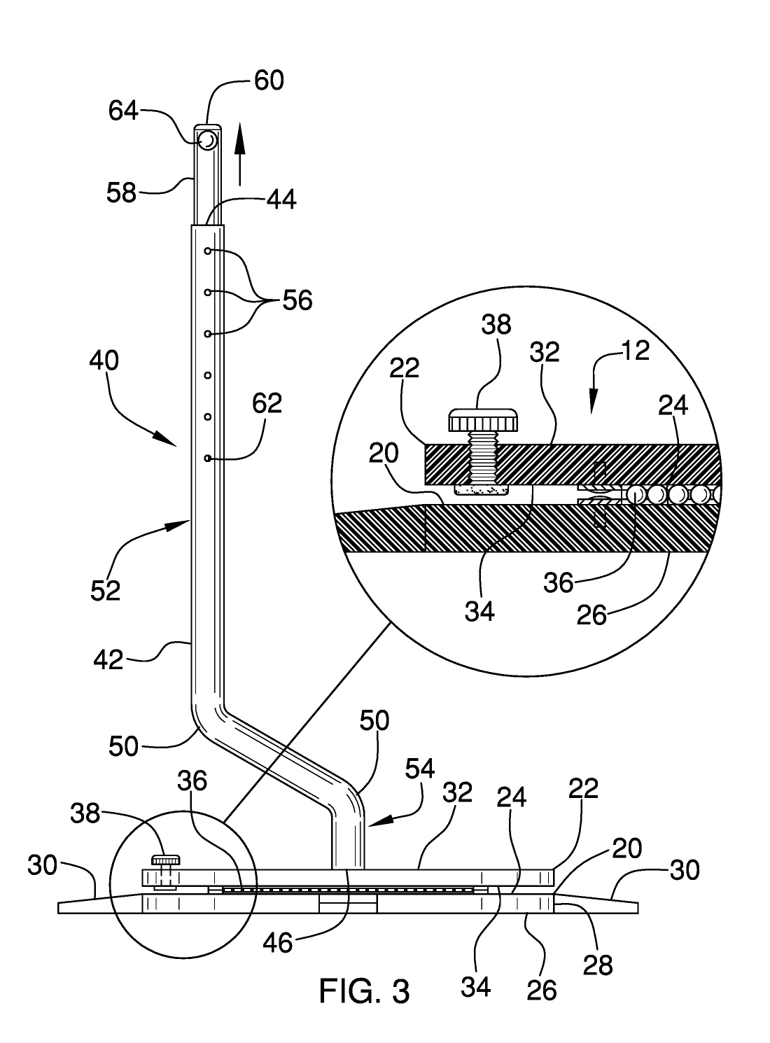

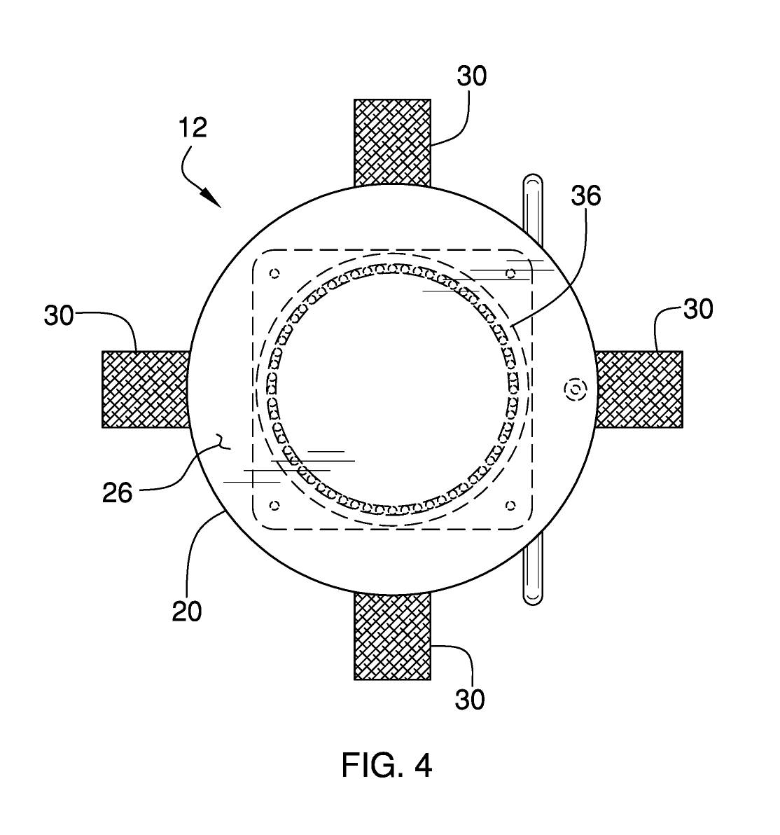

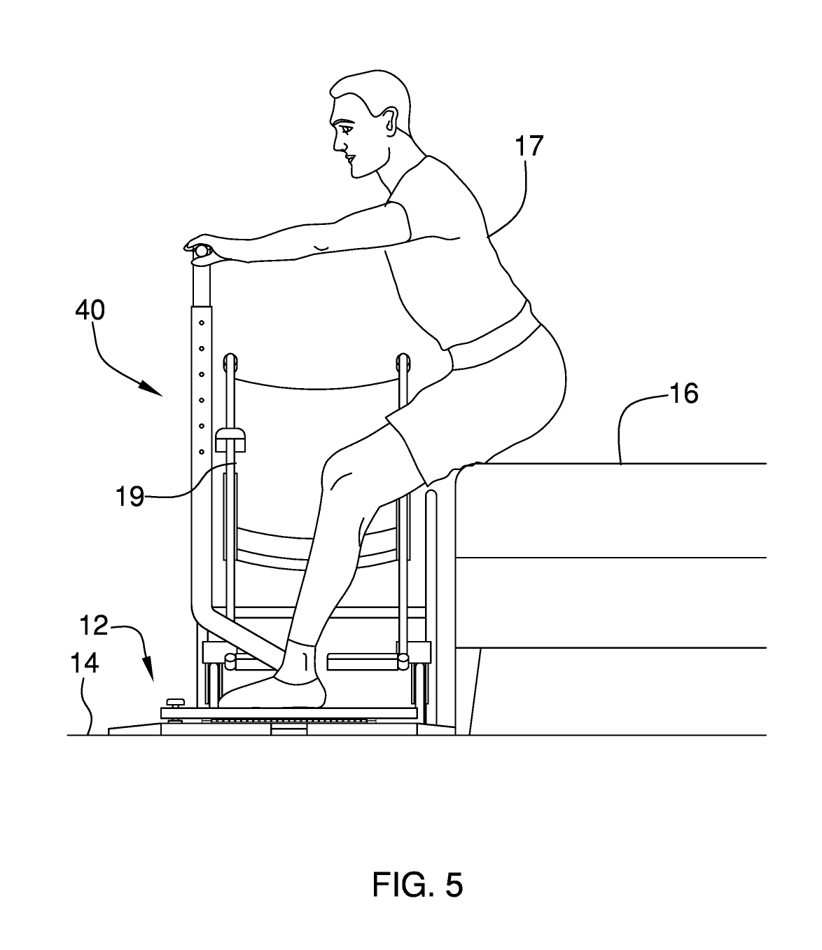

With reference now to the drawings, and in particular to FIGS. 1 through 5 thereof, a new assistance device embodying the principles and concepts of an embodiment of the disclosure and generally designated by the reference numeral 10 will be described.

As best illustrated in FIGS. 1 through 5, the ambulatory assistance assembly 10 generally comprises a base unit 12 that may be positioned on a support surface 14. The support surface 14 may be a floor and the base unit 12 may be aligned with a bed 16 thereby facilitating a user 17 to stand on the base unit 12 when user 17 is getting out of the bed 16. The user 17 may be physically disabled, elderly or otherwise inhibited from moving themselves without assistance from a caregiver. The base unit 12 has a pair of rotatable disks 18 to facilitate the user 17 to align themselves with a wheelchair 19 when the user 17 is standing on the base unit 12.

The pair of rotatable disks 18 includes a first disk 20 and a second disk 22. The first disk 20 has an upper surface 24, a lower surface 26 and a perimeter edge 28 extending therebetween. The lower surface 26 abuts the support surface 14 and the first disk 20 may have a diameter ranging between approximately 45.0 cm and 60.0 cm.

A plurality of feet 30 is provided and each of the feet 30 is coupled to and extends outwardly from the perimeter edge 28. Each of the feet 30 abuts the support surface 14 thereby inhibiting the first disk 20 from tipping. The feet 30 are spaced apart from each other and are distributed around the perimeter edge 28.

The second disk 22 has a top surface 32 and a bottom surface 34. The top surface 32 may be stood upon when the user 17 is transferring themselves between the bed 16 and the wheelchair 19. Additionally, the top surface 32 is texture thereby enhancing traction on the top surface 32. A bearing 36 is provided and the bearing 36 is coupled between the upper surface 24 of the first disk 20 and the bottom surface 34 of the second disk 22. The second disk 22 is rotatably coupled to the first disk 20 having the second disk 22 being selectively rotated about a vertical axis extending through each of the first disk 20 and the second disk 22. In this way the second disk 22 facilitates the user 17 to point themselves in a selected direction when the user 17 is standing on the second disk 22. The bearing 36 reduces friction between the first disk 20 and the second disk 22 and the bearing 36 may be ring shaped ball-bearing 36 or the like.

A lock 38 is movably coupled to the second disk 22 and the lock 38 may be manipulated. The lock 38 extends through the second disk 22 and selectively frictionally engages the first disk 20. In this way the lock 38 selectively retains the second disk 22 at a selected point of rotation about the vertical axis. The lock 38 may comprise a bolt or the like that threadably engages the second disk 22. The bolt may have a distal end with respect to the bottom surface 34 of the second disk 22. A pad may be coupled to the distal end of the bolt and the pad may frictionally engage the first disk 20.

A handle unit 40 is provided and the handle unit 40 is coupled to the base unit 12. The handle unit 40 may be gripped by the user 17 when the user 17 stands on the base unit 12 thereby facilitating the user 17 to selectively lower themselves into the wheelchair 19 and onto the bed 16.

The handle unit 40 comprises a sleeve 42 that has a first end 44, a second end 46 and an outer wall 48 extending therebetween. The second end 46 is coupled to the top surface 32 of the second disk 22 and the sleeve 42 is centrally positioned on the second disk 22. The sleeve 42 has a pair of bends 50 thereon. The bends 50 are spaced apart from each other to define a top portion 52 of the sleeve 42 and a bottom portion 54 of the sleeve 42.

Each of the bends 50 forms an angle and the angle corresponding to each of the bends 50 is congruent with each other such that the top portion 52 of the sleeve 42 is offset with respect to the bottom portion 54 of the sleeve 42. The outer wall 48 has a plurality of apertures 56 each extending into an interior of the sleeve 42. The apertures 56 are spaced apart from each other and are distributed downwardly from the first end 44.

A post 58 is provided and the post 58 is slidably positioned within the first end 44 of the sleeve 42. The post 58 has a distal end 60 with respect to the first end 44. The distal end 60 is spaced a selected distance from the first end 44 of the sleeve 42 such that the post 58 has a telescopically adjustable height. A lock 62 is coupled to the post 58 and the lock 62 may be manipulated. The lock 62 engages a selected one of the apertures 56 such that the post 58 is retained at a selected height with respect to the sleeve 42. The lock 62 may comprise a spring loaded ball or the like.

A handle 64 is provided and the handle 64 is coupled to the distal end 60 of the post 58 and the handle 64 is oriented perpendicular to the post 58. The handle 64 is gripped when the user 17 stands on the second disk 22. In this way the handle 64 facilitates the user 17 to stabilize themselves when the user 17 is standing on the second disk 22. Moreover, the bends 50 on the sleeve 42 facilitate the user 17 to bend at the knees within having the user 17's knees engaging the top portion 52 of the sleeve 42.

In use, the base unit 12 is positioned adjacent to the bed 16 having the first disk 20 abutting the support surface 14. The user 17 grips the handle 64 and the user 17 places the user 17's feet on the second disk 22. The user 17 stands up onto the second disk 22 and the user 17 manipulates the handle 64 to rotate the second disk 22. Moreover, the user 17 rotates the second disk 22 to align themselves with a wheelchair 19 or the like. The user 17 bends at the knees to sit in the wheelchair 19. In this way, the base unit 12 and the handle unit 40 facilitate the user 17 to transfer between the bed 16 and the wheelchair 19 with minimal assistance from a caregiver. Moreover, the base unit 12 and the handle unit 40 reduce the likelihood of the caregiver suffering a back injury resulting from physically transferring the user 17 between the bed 16 and the wheelchair 19.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An ambulatory assistance assembly being configured to assist a physically disabled user to move from a bed to a wheelchair, said assembly comprising:
a base unit being configured to be positioned on a support surface, said base unit being configured to be aligned with a bed thereby facilitating a user to stand on said base unit, said base unit having a pair of rotatable disks wherein said rotatable disks are configured to facilitate the user to align themselves with a wheelchair when the user is standing on said base unit; and
a handle unit being coupled to said base unit wherein said handle unit is configured to be gripped by the user when the user stands on said base unit thereby facilitating the user to selectively transfer themselves between the wheelchair and the bed.

2. The assembly according to claim 1, wherein said pair of rotatable disks includes a first disk, said first disk having an upper surface, a lower surface and a perimeter edge extending therebetween, said lower surface being configured to abut the support surface.

3. The assembly according to claim 2, further comprising a plurality of feet, each of said feet being coupled to and extending outwardly from said perimeter edge wherein each of said feet is configured to abut the support surface thereby inhibiting said first disk from tipping, said feet being spaced apart from each other and being distributed around said perimeter edge.

4. The assembly according to claim 1, wherein said pair of rotatable disks includes a second disk, said second disk has a top surface and a bottom surface, said top surface being configured to be stood upon when the user is transferring themselves between the bed and the wheelchair.

5. The assembly according to claim 4, further comprising:
a first disk having an upper surface; and
a bearing being coupled between said upper surface of said first disk and said bottom surface of said second disk such that said second disk is rotatably coupled to said first disk having said second disk being selectively rotated about a vertical axis extending through each of said first disk and said second disk wherein said second disk is configured to facilitate the user to point themselves in a selected direction when the user is standing on said second disk, said bearing reducing friction between said first disk and said second disk.

6. The assembly according to claim 5, further comprising:
a first disk; and
a lock being movably coupled to said second disk wherein said lock is configured to be manipulated, said lock extending through said second disk and selectively frictionally engaging said first disk such that said lock selectively retains said second disk at a selected point of rotation about said vertical axis.

7. The assembly according to claim 4, wherein said handle unit comprises a sleeve having a first end, a second end and an outer wall extending therebetween, said second end being coupled to said top surface of said second disk, said sleeve being centrally positioned on said second disk.

8. The assembly according to claim 7, wherein said sleeve has a pair of bends thereon, said bends being spaced apart from each other to define a top portion of said sleeve and a bottom portion of said sleeve, each of said bends forming an angle, said angle corresponding to each of said bends being congruent with each other such that said top portion of said sleeve is offset with respect to said bottom portion of said sleeve.

9. The assembly according to claim 7, wherein said outer wall has a plurality of apertures each extending into an interior of said sleeve, said apertures being spaced apart from each other and being distributed downwardly from said first end.

10. The assembly according to claim 7, further comprising a post being slidably positioned within said first end of said sleeve such, said post having a distal end with respect to said first end, said distal end being spaced a selected distance from said first end of said sleeve such that said post has a telescopically adjustable height.

11. The assembly according to claim 10, further comprising:
a plurality of apertures extending through said sleeve; and
a lock being coupled to said post wherein said lock is configured to be manipulated, said lock engaging a selected one of said apertures such that said post is retained at a selected height with respect to said sleeve.

12. The assembly according to claim 10, further comprising a handle being coupled to said distal end of said post wherein said handle is configured to be manipulated, said handle being oriented perpendicular to said post.

13. An ambulatory assistance assembly being configured to assist a physically disabled user to move from a bed to a wheelchair, said assembly comprising:
a base unit being configured to be positioned on a support surface, said base unit being configured to be aligned with a bed thereby facilitating a user to stand on said base unit, said base unit having a pair of rotatable disks wherein said rotatable disks are configured to facilitate the user to align themselves with a wheelchair when the user is standing on said base unit, said base unit comprising:
said pair of rotatable disks including a first disk and a second disk,
said first disk having an upper surface, a lower surface and a perimeter edge extending therebetween, said lower surface being configured to abut the support surface,
a plurality of feet, each of said feet being coupled to and extending outwardly from said perimeter edge wherein each of said feet is configured to abut the support surface thereby inhibiting said first disk from tipping, said feet being spaced apart from each other and being distributed around said perimeter edge,
said second disk having a top surface and a bottom surface, said top surface being configured to be stood upon when the user is transferring themselves between the bed and the wheelchair,
a bearing being coupled between said upper surface of said first disk and said bottom surface of said second disk such that said second disk is rotatably coupled to said first disk having said second disk being selectively rotated about a vertical axis extending through each of said first disk and said second disk wherein said second disk is configured to facilitate the user to point themselves in a selected direction when the user is standing on said second disk, said bearing reducing friction between said first disk and said second disk,
a lock being movably coupled to said second disk wherein said lock is configured to be manipulated, said lock extending through said second disk and selectively frictionally engaging said first disk such that said lock selectively retains said second disk at a selected point of rotation about said vertical axis; and
a handle unit being coupled to said base unit wherein said handle unit is configured to be gripped by the user when the user stands on said base unit thereby facilitating the user to selectively transfer themselves between the wheelchair and the bed, said handle unit comprising:
a sleeve having a first end, a second end and an outer wall extending therebetween, said second end being coupled to said top surface of said second disk, said sleeve being centrally positioned on said second disk, said sleeve having a pair of bends thereon, said bends being spaced apart from each other to define a top portion of said sleeve and a bottom portion of said sleeve, each of said bends forming an angle, said angle corresponding to each of said bends being congruent with each other such that said top portion of said sleeve is offset with respect to said bottom portion of said sleeve, said outer wall having a plurality of apertures each extending into an interior of said sleeve, said apertures being spaced apart from each other and being distributed downwardly from said first end,
a post being slidably positioned within said first end of said sleeve such, said post having a distal end with respect to said first end, said distal end being spaced a selected distance from said first end of said sleeve such that said post has a telescopically adjustable height,
a lock being coupled to said post wherein said lock is configured to be manipulated, said lock engaging a selected one of said apertures such that said post is retained at a selected height with respect to said sleeve, and
a handle being coupled to said distal end of said post wherein said handle is configured to be manipulated, said handle being oriented perpendicular to said post.
